(19) United States
(12) Patent Application Publication
(10) Pub. No.: US 2016/0277526 A1
(43) Pub. Date: Sep. 22, 2016

(54) SYSTEMS AND METHODS FOR DETERMINING HOUSEHOLD MEMBERSHIP

(71) Applicant: Facebook, Inc., Menlo Park, CA (US)

(72) Inventors: William Bullock, Palo Alto, CA (US); Carlos Gregorio Diuk Wasser, Mountain View, CA (US)

(21) Appl. No.: 14/662,124

(22) Filed: Mar. 18, 2015

(51) Int. Cl. H04L 29/08

(52) U.S. Cl. CPC H04L 67/306

(57) ABSTRACT

Systems, methods, and non-transitory computer-readable media can determine attribute information associated with attributes. The attribute information is associated with a first user and a second user. Match values for the attributes are determined based on the attribute information. A first rule is applied to the match values. The first user and the second user are predicted to be members in a first common household based on satisfaction of the first rule by the match values.

### FIELD OF THE INVENTION

The present technology relates to the field of social networks. More particularly, the present technology relates to techniques for determining household membership.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system. In some instances, however, illegitimate users may attempt to perform illegitimate or undesirable operations, such as by attempting to post malicious or spam links via the social networking system.

User experience associated with a social networking system can be enhanced as the social networking system becomes more knowledgeable about the users that it serves. When knowledge of a user is gained, content, advertising, and potentially other services can be optimized for presentation to the user. Such potentially helpful knowledge about the user can include information about the user as an individual. Such information also can information about a group or organization of which the user is a member.

### SUMMARY

Various embodiments of the present disclosure can include systems, methods, and non-transitory computer readable media configured to determine attribute information associated with attributes. The attribute information is associated with a first user and a second user. Match values for the attributes are determined based on the attribute information. A first rule is applied to the match values. The first user and the second user are predicted to be members in a first common household based on satisfaction of the first rule by the match values.

In an embodiment, an extent to which a condition associated with an attribute is satisfied is determined. A match value is assigned based on the extent to which the condition associated with the attribute is satisfied.

In an embodiment, the attributes include at least one of a friend attribute, a tie-strength attribute, a spouse attribute, a parent attribute, a shared device attribute, a zip code attribute, a city attribute, an IP address attribute, a last name attribute, and an age attribute.

In an embodiment, the first user is a member of a social networking system and the attribute information associated with the first user is known by the social networking system.

In an embodiment, the at least one rule includes a set of requirements associated with at least a subset of the attributes.

In an embodiment, the set of requirements includes at least one of a minimum match value, a maximum match value, and an identical match value associated with an attribute.

In an embodiment, a second rule is applied to the match values when the first rule is not satisfied, the second rule including a set of requirements different from a set of requirements included in the first rule.

In an embodiment, the second user and a third user are predicted to be in a second common household based on satisfaction of a second rule. The first user, the second user, and the third user are determined to be in a common household without application of the first rule and the second rule.

In an embodiment, the first user and the second user are identified as a pair for determination of possible common household membership based on at least one match associated with a threshold number of attributes.

In an embodiment, a machine learning technique is applied to update a set of requirements associated with the first rule based on accurate household membership information.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example household determination module, according to an embodiment of the present disclosure.

FIG. 2 illustrates an example household analysis module, according to an embodiment of the present disclosure.

FIG. 3 illustrates an example table of attribute values, according to an embodiment of the present disclosure.

FIG. 4 illustrates example rules, according to an embodiment of the present disclosure.

FIG. 5 illustrates an example connection graph, according to an embodiment of the present disclosure.

FIG. 6 illustrates an example method to determine a common household relationship, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Household Relationship Determination

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can provide, post, or publish content items, such as text, notes, status updates, links, pictures, videos, and audio, via the social networking system. Users also can access and experience content of almost every variety of type and form.

As a social networking system learns more about a user, the experience of the user in connection with the social networking system can be enhanced. The profile and interactions of the user as well as the profile and interactions of connections of the user can provide important information about the user. This information can be leveraged by the social networking system to optimize the presentation of relevant content, advertising, and other services to the user. While it often can glean some information about a particular user, a conventional social networking system in many instances cannot reliably ascertain membership of the household to which the user belongs.

Household membership information regarding a user can be a critical factor in achieving a comprehensive view of the interests and needs of user as well as of other members in the household of the user. Often, the needs or interests of a user will depend on or otherwise correlate with the needs or interests of other members in the same household. For example, to target services for a user in a household, it can be important to first understand and measure the type and magnitude of historical use of related services by all members in the household. Without household membership information, the ability of a social networking system to optimize the presentation or delivery of services to a user can be significantly compromised.

Therefore, an improved approach can be beneficial for addressing or alleviating various concerns associated with conventional approaches. The disclosed technology can provide a determination of household membership based on consideration of attributes associated with users. The attributes are used as a basis to identify pairs of users. When consideration of attributes associated with two users results in matches based on a threshold number of the attributes, the two users can be paired together to perform further analysis regarding whether the two users are likely to be members of the same household. The analysis can determine match values based on consideration of attribute information associated with the two users. Rules can be applied to the match values to predict whether the two users are likely to be members in the same household. Connection techniques can be used to further identify common household members without the application of the rules. The disclosed technology can be updated and revised as sources of truth are available to validate determinations of household membership.

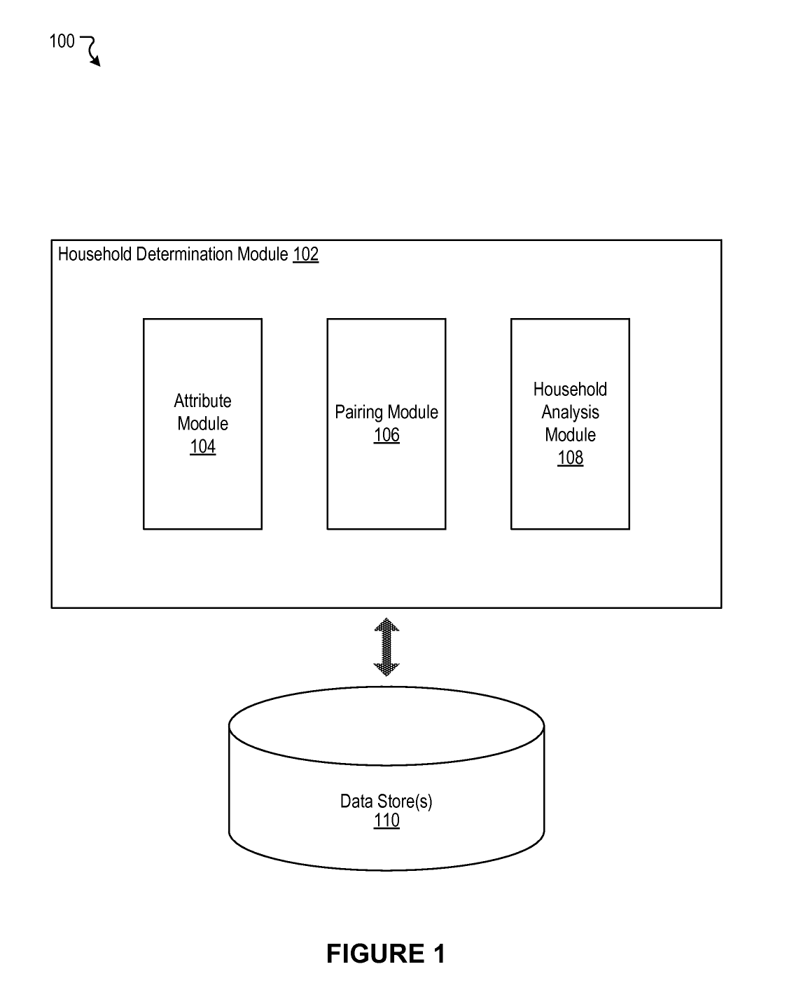

FIG. 1 illustrates an example system 100 including an example household determination module 102 configured to facilitate predicting members in a household, according to an embodiment of the present disclosure. As shown in the example of FIG. 1, the household determination module 102 can include an attribute module 104, a paring module 106, and a household analysis module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. While two users (or a pair of users) are discussed as an example in relation to the household determination module 102, the household determination module 102 can be based on any number of users instead of two users. While a social networking system is described in connection with some embodiments, users do not need to be connected with one another in the social networking system in order to be identified as being part of a household in some embodiments. For example, users in a common household may choose not to connect with one another or choose to block one another in certain circumstances. Further, in some embodiments, users do not need to have specified the nature of their relationship with one another (e.g., spouse, parent, child, etc.) in the social networking system. Determinations of membership in a common household are not shared outside of the social networking system.

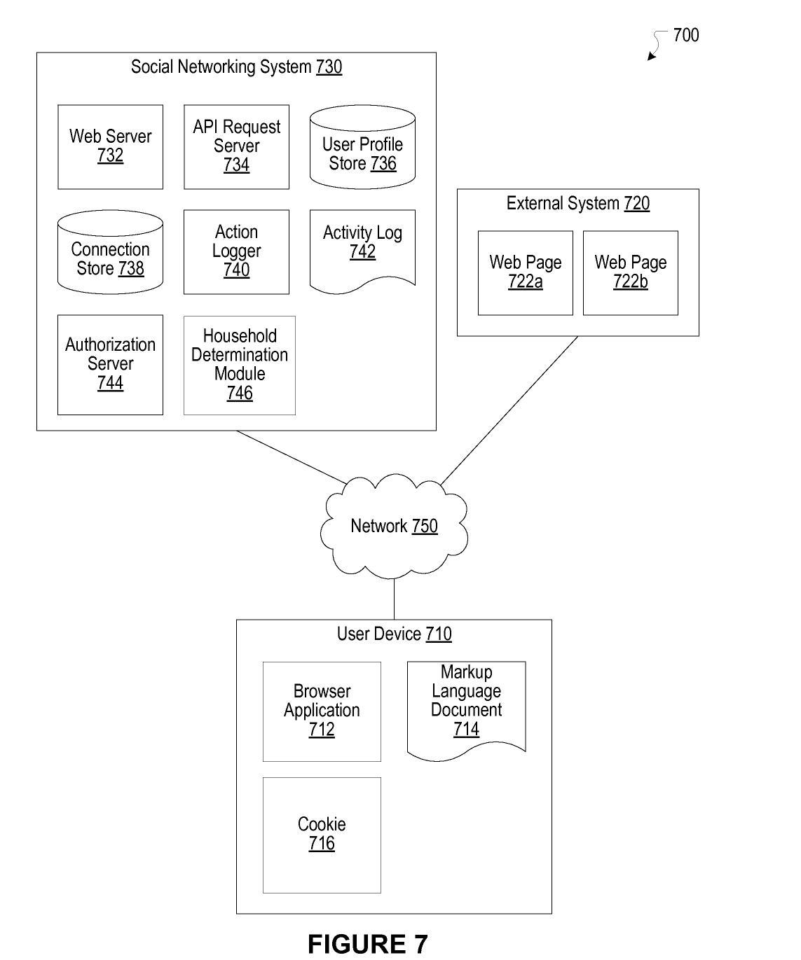

The household determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the household determination module 102 can be implemented, in part or in whole, as software running on one or more computing devices or systems, such as on a server computing system or a user (or client) computing system. For example, the household determination module 102 or at least a portion thereof can be implemented as or within an application (e.g., app), a program, or an applet, etc., running on a user computing device or a client computing system, such as the user device 710 of FIG. 7. In another example, the household determination module 102 or at least a portion thereof can be implemented using one or more computing devices or systems that include one or more servers, such as network servers or cloud servers. In some instances, the household determination module 102 can, in part or in whole, be implemented within or configured to operate in conjunction with a social networking system (or service), such as the social networking system 730 of FIG. 7. It should be understood that there can be many variations or other possibilities.

Furthermore, in some embodiments, the household determination module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the household determination module 102. For instance, the data store 110 can store attributes, attribute information associated with users, association (e.g., pairings) of users based on matches of attributes, match values based on the attribute information, rules to determine household membership among users, threshold values with respect match values, and accurate common household information from sources of truth. It is contemplated that there can be many variations or other possibilities.

The attribute module 104 can be configured to select attributes of users that are used by the household determination module 102. The attributes can include any consideration that may inform a determination about whether two (or more) users are members in the same household. The attributes can be selected by the social networking system. The attributes can include but are not limited to the following attributes:

Friend: This attribute relates to whether users are direct connections in the social networking system. In some instances, a tie-strength attribute, which is different from the friend attribute, relates to the relative tie strength between users, regardless of whether they are connections in the social networking system or not. The tie-strength attribute can be expressed as a coefficient score. In practice, the tie-strength attribute, which can indicate that two users have a pattern of liking each other's posts, sharing items with each other, or otherwise interacting with each other, can be used as a positive signal that the two users are more likely living together than two others who rarely interact with one another in the social networking system.

Spouse: This attribute relates to whether the users are related as spouses.

Parent: This attribute relates to whether the users are related as parent and child.

Shared Device (or Cookie): This attribute relates to whether the users use a common computing system to access the social networking system. A determination of a common computing system can be based on a persistent cookie. The cookie can indicate the hardware (e.g., desktop device, laptop device, tablet device, mobile device, etc.) and software (e.g., browser, application, etc.) of the computing system. The determination of a common computing system can be based on the use by the two users of the same hardware, the use by the two users of the same software, or the use by the two users of both the same hardware and the same software. Further, whether two users are using the same mobile device can be detected based on app (application) usage. When one or more apps (applications) associated with a social networking system (e.g., a general application associated with the social networking system, a messenger application associated with the social networking system, an advertising management application associated with the social networking system, etc.) are installed on a mobile device, the apps share a unique identifier. The social networking system can maintain logs of which users use the apps, which allows the social networking system to determine whether multiple users are leveraging the same mobile device.

Zip Code (or Postal Code): This attributes relates to whether the residences of the users are associated with the same zip code or postal code.

City: This attribute relates to whether the residences of the users are associated with the same city.

IP Address: This attribute relates to whether the IP addresses of the computing systems used by the users to access the social networking system are the same. In some embodiments, the IP address of the users that have been used within a selected time duration (e.g., one week, 30 days, 60 days, etc.) at a selected specific time window (e.g., 7 pm-7 am, 6:30 pm-11:30 pm, etc.) can be considered to determine a common IP address between users.

Last Name: This attribute relates to whether the users share a common last name.

Age: This attribute relates to whether one of the users is within a selected age range. For example, a selected age range can be between 13 years of age and 17 years of age.

In some embodiments, attributes in addition to the example attributes enumerated above can be selected for use by the household determination module 102. In some embodiments, a subset of the example attributes enumerated above can be used by the household determination module 102. As discussed in more detail herein, the social networking system can continuously or periodically identify relevant attributes to optimize the determination of household membership. As a result, additional attributes can be selected for the determination of household membership. Likewise, attributes can be removed from consideration in the determination of household membership. In some embodiments, different attributes can be selected for different regions (e.g., countries) or markets. For example, attributes selected for developed markets may differ from those selected for developing markets.

The pairing module 106 can be configured to identify whether a number (e.g., two) of users should be analyzed for potential membership in a common household. The pairing module 106 can analyze the selected attributes to determine whether for two users a match exists, or the extent to which a match may exist, as to one or more attributes. With respect to an attribute, a match can represent satisfaction to a threshold level of a condition associated with the attribute. For example, with respect to the spouse attribute, when a first user and a second user are determined to have a spousal relationship, a match can be determined. As another example, with respect to the IP address attribute, when a first user and a second user are determined to have a common IP address, a match can be determined.

The pairing module 106 can be configured to identify whether a number (e.g., two) of users should be analyzed for potential membership in a common household. The pairing module 106 can analyze the selected attributes to determine whether for two users a match exists, or the extent to which a match may exist, as to one or more attributes. With respect to an attribute, a match can represent satisfaction to a threshold level of a condition associated with the attribute. For example, with respect to the spouse attribute, when a first user and a second user are determined to have a spousal relationship, a match can be determined. As another example, with respect to the IP address attribute, when a first user and a second user are determined to have a common IP address, a match can be determined.

In some embodiments, when matches for the threshold number of attributes between two users are determined, the pairing module 106 can pair the two users. In this regard, no further analysis of matches for additional attributes between the two users need be performed to determine whether to pair the users. In some embodiments, when matches for the threshold number of attributes are not determined, the pairing module 106 does not pair the two users. The threshold number of attributes for which matches must be determined can be any suitable number. In some embodiments, the pairing module 106 need not be implemented in the household determination module 102.

The household analysis module 108 can be configured to predict whether a number (e.g., two, five, etc.) of users are members of a common household. In some embodiments, the users and, in particular, the pairs of users to be considered for possible membership in a common household may be determined by the pairing module 106. The household analysis module 108 can retrieve information regarding the attribute information for each user in a pair. The attribute information for the users can be considered and a match value can be determined based on consideration of attribute information for the two users for each attribute. One or more rules can be applied to match values for various attributes. The rules can include a set of requirements that one or more of the match values for the attributes satisfy certain threshold values or required values. When the set of requirements associated with a rule are satisfied, the users can be determined to likely be members of a common household. Further members of a household can be identified based on connection techniques that are not based on the rules. The techniques to determine common household membership can be refined over time based on the receipt of household membership information from authoritative sources. The household analysis module 108 is discussed in more detail herein. In some embodiments, variable match-strength components can be implemented to ensure that households do not grow beyond suitable thresholds. For example, a first threshold can be used to assign two users in a common household if neither user would otherwise be householded (assigned to a household) and if the two users are reciprocal “top choices” for assignment to a common household. A second threshold, higher than the first threshold, can be used on a user-specific basis for householding and can increase as a user is connected to more people.

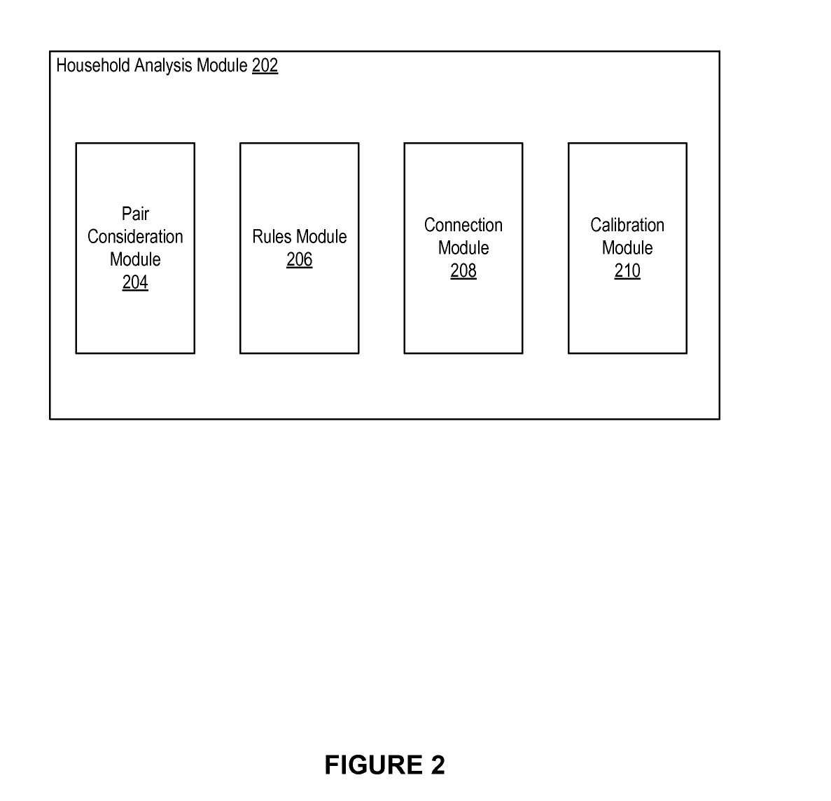

FIG. 2 illustrates an example household analysis module 202 configured to predict whether a number (e.g., two, five, etc.) of users are members of a common household, according to an embodiment of the present disclosure. In some embodiments, the household analysis module 108 of FIG. 1 can be implemented as the example household analysis module 202. As shown in FIG. 2, the household analysis module 202 can include a pair consideration module 204, a rules module 206, a connection module 208, and a calibration module 210.

The pair consideration module 204 can be configured to receive attribute information regarding the attributes associated with all (or some) pairs of users to be considered for possible membership in a common household. In some embodiments, the pairs of users to be considered may be determined by the pairing module 106. The pair consideration module 204 can receive attribute information regarding each pair of users from data maintained by the social networking system. Such data can be maintained by, for example, the data store 110. The attribute information can include profile information that each user has provided to the social networking system and interaction information based on activities of the user with the social networking system. For example, with respect to the age attribute, a user may have expressly provided his or her age to the social networking system during a registration process. As another example, with respect to the spouse attribute, a user may have expressly identified his or her spouse in interactions with the social networking system. As yet another example, with respect to the city attribute, the social networking system may have inferred the residential city of a user based on the known residential locations of close friends of the user. The attribute information of two users that is used to determine a match value with respect to an attribute can be known or inferred by the social networking system in a variety of manners.

For each pair of users, the pair consideration module 204 can determine or assign match values based on the attribute information of the two users. Each match value for an attribute represents an extent to which a condition associated with the attribute is satisfied. Match values can be binary values, fractional values, real numbers, integers, or any other suitable types of match values. One or more of the types of match values can be used in any suitable combination.

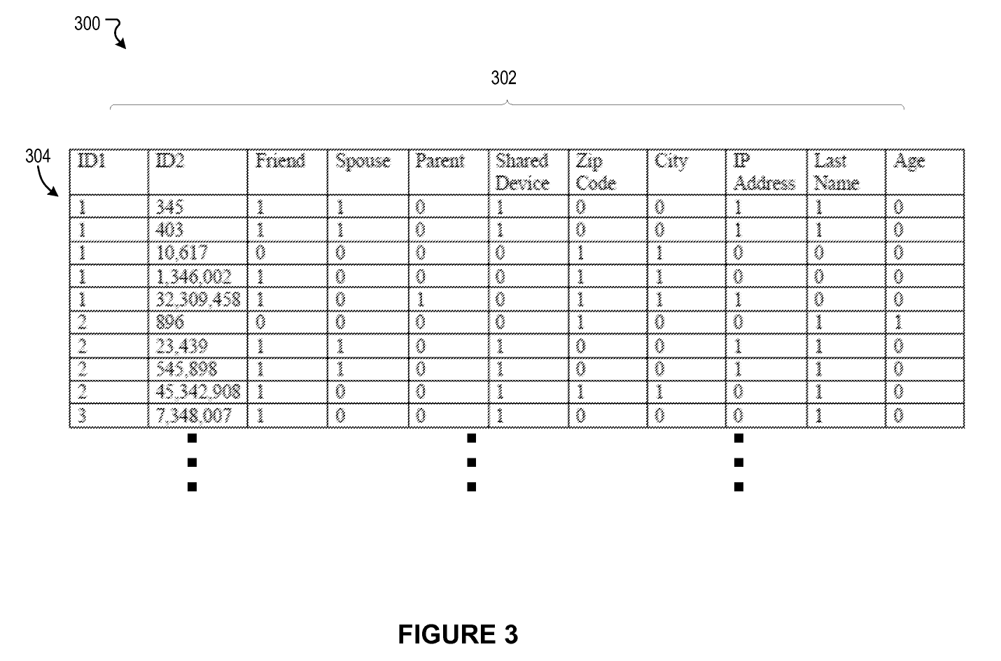

FIG. 3 illustrates an example table 300 of example match values associated with each attribute based on whether (or the extent to which) a match is identified, according to an embodiment of the present disclosure. The table 300 is a graphical representation of match values determined by the pair consideration module 204. The table 300 reflects numerous pairs of users for whom a determination is to be made regarding whether each pair of users is likely to belong to a common household. The table 300 includes columns 302 corresponding to two users and match values associated with attributes. In particular, the columns 302 include a first identifier for a first user in a pair of users and a second identifier for a second user in the pair of users. The columns 302 also include the following attributes: a friend attribute, a spouse attribute, a parent attribute, a shared device (or cookie) attribute, a zip code attribute, a city attribute, an IP address attribute, a last name attribute, and an age attribute. Although columns 302 include two users and the example attributes reflected in the table 300, a different number of users and different attributes can be used in other embodiments. For example, a tie-strength attribute or other attribute(s) can be added to supplement or replace one or more of the attributes reflected in the table 300.

Each row in the table 300 represents a pair of users and a match value for each attribute based on whether or an extent to which a match associated with the attribute is identified for the pair of users. For example, a row 304 in the table 300 represents a first user in a pair of users associated with a unique identifier of “1” and a second user in the pair of users associated with a unique identifier of “345”. Other rows represent other pairings of users.

The row 304 includes various match values. With respect to the friend attribute, the pair consideration module 204 has determined that the first user and the second user are direct connections. As a result, the pair consideration module 204 has assigned the friend attribute a match value of “1” for the first user and the second user. With respect to the spouse attribute, the pair consideration module 204 has determined that the first user and the second user are related as spouses. As a result, the pair consideration module 204 has assigned the spouse attribute a match value of “1” for the first user and the second user. With respect to the parent attribute, the pair consideration module 204 has determined that the first user and the second user are not related as parent and child. As a result, the pair consideration module 204 has assigned the parent attribute a match value of “0” for the first user and the second user. With respect to the shared device attribute, the pair consideration module 204 has determined that the first user and the second user both use the same computing system to access the social networking system. As a result, the pair consideration module 204 has assigned the shared device attribute a match value of “1” for the first user and the second user. With respect to the zip code attribute, the pair consideration module 204 has determined that the first user and the second user do not reside in the same zip code. As a result, the pair consideration module 204 has assigned the zip code attribute a match value of “0” for the first user and the second user. With respect to the city attribute, the pair consideration module 204 has determined that the first user and the second user do not reside in the same city. As a result, the pair consideration module 204 has assigned the city attribute a match value of “0” for the first user and the second user. With respect to the IP address attribute, the pair consideration module 204 has determined that the first user and the second user are both associated with the same IP address during a selected time duration at a particular time window. As a result, the pair consideration module 204 has assigned the IP address attribute a match value of “1” for the first user and the second user. With respect to the last name attribute, the pair consideration module 204 has determined that the first user and the second user have the same last name. As a result, the pair consideration module 204 has assigned the last name attribute a match value of “1” for the first user and the second user. With respect to the age attribute, the pair consideration module 204 has determined that neither the first user nor the second user fall within a selected age range. As a result, the pair consideration module 204 has assigned the age attribute a value of “0” for the first user and the second user. Like the row 304, other rows of the chart 300 reflect the identity of a pair of users and match values associated with the attributes based on whether or the extent to which a match is determined as between the two users.

As discussed herein, the match values assigned for attributes can be of various types. In some embodiments, the match values can be binary values, as shown in FIG. 3. In some embodiments, the match values also can be other values that may reflect the extent to which or probability with which a match is identified for a pair of users. For example, in addition to or as an alternative to binary values, a fraction or real number can be assigned as a match value for an attribute to reflect the extent to which or probability with which a match is identified for a pair of users. In some instances, the fraction or real number can fall within a selected range of values. For example, a selected range can be a range between a value of “0” and a value of “1”, where a value of “0” represents a lowest probability that a condition associated with an attribute is satisfied, a value of “1” represents a highest probability that the condition associated with the attribute is satisfied, and a value between “0” and “1” represents an intermediate probability that the condition associated with the attribute is satisfied.

As shown in FIG. 2, the rules module 206 can be configured to define and apply one or more rules to determine whether a pair of users is likely to be in the same household. Each rule can include a set of requirements for consideration of some or all attributes, or their associated attribute values (e.g., minimum match values), for a pair of users. The set of requirements must be satisfied before the pair of users is identified as likely belonging to the same household. In some embodiments, the set of requirements may include required or minimum (or maximum) match values for some or all attributes.

The rules module 206 can define and apply a plurality of independent rules, each rule of which can separately determine whether two users are likely to be members in the same household. The plurality of rules can have some common requirements and some different requirements across rules. Common requirements across rules may represent required, but perhaps not sufficient, signals of membership in a common household. For example, among other potential requirements, a first rule can require a selected match value for a first attribute and a second rule can likewise require the selected match value for the first attribute. In this regard, the first rule and the second rule both, for example, can require at least that the two users are direct connections.

Further, different rules may reflect different emphasis for particular attributes. For example, a match value reflecting a high probability (e.g., match value of “1”) that a condition associated with a key attribute (e.g., friend attribute) is satisfied may be an indication of common household membership with a high level of confidence. As a result, to achieve a strong indication of common household membership, a rule can be defined to require the match value reflecting high probability for a key attribute and not to require any match values reflecting high probability for other attributes. As a related matter, another rule can be defined to require match values reflecting high probabilities for other attributes in the absence of a match value reflecting a high probability for a key attribute. Such a rule can compensate for the absence of a key attribute while ensuring a determination of common household membership with a high level of confidence.

In general, each rule can emphasize different attributes in different combinations. In some embodiments, each rule can selectively weight the importance of each attribute to the rule so that each attribute potentially can have a unique weight. For example, each attribute or associated match value can be multiplied by a number between “0” and “1” based on the importance of the attribute. Further, some rules can require different match values for the same attributes while other rules can consider different attributes. For example, a first rule can require a first selected match value for a first attribute, a second selected match value for a second attribute, and a third selected match value for a third attribute. A second rule can require the first selected match value for the first attribute, a fourth selected match value different from the second selected match value for the second attribute, and a fifth selected match value for a fourth attribute. Many variations are possible.

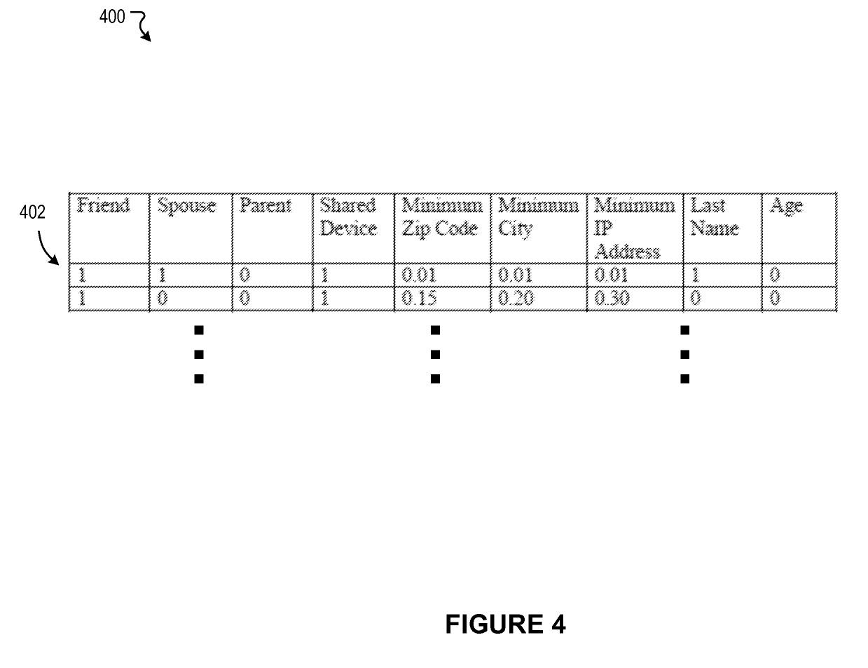

FIG. 4 illustrates an example table 400 of example rules to determine that two users are likely members of a common household, according to an embodiment of the present disclosure. The rules can be applied by the rules module 206 to the match values assigned by the pair consideration module 204. Each row of the table 400 represents a rule. The rule represented by a row includes a set of requirements regarding required attributes and associated required match values.

For example, a row 402 of the table 400 represents an example rule to determine that two users are likely members of a common household. The example rule reflected in the row 402 requires a first user and a second user to be direct connections; the first user and the second user to be related as spouses; the first user and the second user to use the same computing system; and, the first user and the second user to have the same last name. The example rule reflected in the row 402 further requires that the match value for the zip code attribute to be at least a minimum match value of 0.01; the match value for the city attribute to be at least a minimum match value of 0.01; and, the match value for the IP address to be at least a minimum match value of 0.01. The example rule reflected in the row 402 further requires that the first user and the second user are not related as parent and child. The example rule reflected in the row 402 further requires or considers irrelevant that neither the first user nor the second user are within a selected age range.

The required minimum match values for the zip code attribute, the city attribute, and the IP attribute can indicate that the possible match values for these attributes can fall within a selected range of match values. The selected range of match values for these attributes can reflect an understanding that, in some instances, whether two users are in the same zip code or the same city, or are associated with the same IP address, in some instances cannot be determined definitively and are better reflected as probabilities that can be quantitatively expressed through the selected range of values. In some embodiments, attributes additional or alternative to the zip code attribute, the city attribute, and the IP attribute can be assigned match values in a selected range of values. In some embodiments, rules to determine likely membership in a common household can be based on minimum match values, maximum match values, required match values, or a combination thereof.

The rules module 206 can determine that a rule is satisfied with respect to two users. Based on a determination that a rule is satisfied, the rules module 206 can determine that the two users likely are members of a common household with a threshold level of confidence. When a rule is not satisfied with respect to the two users, the rules module 206 can apply additional rules that can determine likely common household membership based on other requirements associated with the rules. In some embodiments, the rules module 206 can determine common household membership when one rule is satisfied. In some embodiments, the rules module 206 can determine common household membership when a selected number of rules are satisfied. Required satisfaction of more than one rule can allow the rules module 206 to determine common household membership with a relatively higher level of confidence. The level of confidence for determination of common household membership can be proportional to the number of rules satisfied.

The connection module 208 can be configured to determine common household membership for two users without application of the rules applied by the rules module 206. The connection module 208 can apply one or more connection techniques (e.g., daisy chaining) to two users and determine that the two users belong to a common household. In particular, the connection module 208 can analyze pairs of users determined by the rules module 206 to likely be in a common household. If a first user and a second user in a first pair of users are determined to likely be in a common household and the second user and a third user in a second pair of users are determined to likely be in a common household, then the connection module 208 can determine that the first user and the third user are likely members in the common household that includes the second user.

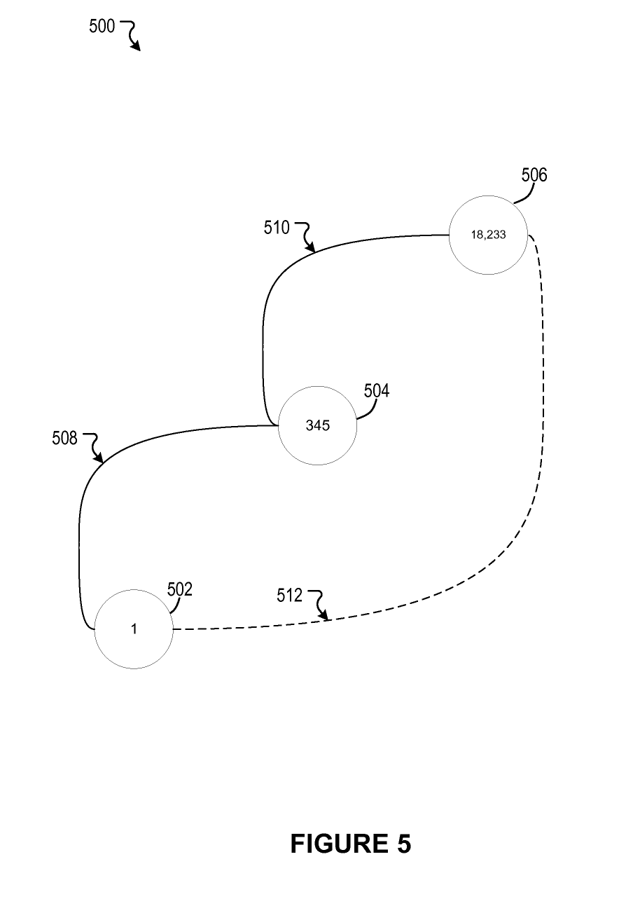

FIG. 5 is an example connection graph 500 that connects a plurality of users, according to an embodiment of the present disclosure. The connection graph 500 can be a visual representation of the connections determined by the connection module 208. The connection graph 500 includes a representation of three users: a user 502 associated with an identifier “1”, a user 504 associated with an identifier “345”, and a user 506 associated with an identifier “18,233”. The user 502 is connected to the user 504. A line 508 represents the connection between the user 502 and the user 504 and their likely common household membership. The user 504 is connected to the user 506. A line 510 represents the connection between the user 504 and the user 506 and their likely common household membership. In some embodiments, the common household membership represented by the lines 508, 510 can be determined by the rules module 206.

Because the user 504 belongs to a common household with the user 502 and because the user 504 belongs to a common household with the user 506, the connection module 208 can infer that the user 502 and the user 506 also belong to a common household. The determined common household membership of the user 502 and the user 506 is represented by a dotted line 512. As a result, the user 502, the user 504, and the user 506 are determined to be members of a common household. The determined common household membership of the user 502 and the user 506 need not be based on the rules applied by the rules module 206.

The connection module 208 can apply the connection techniques to some or all pairs of users determined to be members of a common household. By doing so, the connection module 208 can potentially determine common household membership that extends beyond two users. The use of the connection techniques by the connection module 208 can more efficiently and comprehensively determine common household membership without exclusive reliance on the rules applied by the rules module 206.

As shown in FIG. 2, the calibration module 210 can be configured to update, modify, and otherwise improve the household analysis module 202. The calibration module 210 can improve the household analysis module 202 based on various sources of accurate household membership data. Such sources can include but are not limited to user feedback, census data, and demographic statistics.

The calibration module 210 can employ manual or machine learning techniques based on accurate household membership data to update various techniques or parameters used by the household analysis module 202. For example, the calibration module 210 can optimize the selection of attributes by the pairing module 106 to create pairs of users for further analysis as to common household membership. If certain attributes are not highly correlated with identification of pairs of users that likely belong to a common household membership or if new but previously unconsidered attributes are so highly correlated, appropriate action can be taken by the calibration module 210. As another example, the calibration module 210 can optimize the definition and application of rules to identify pairs of users in a common household. If certain rules do not identify common household membership with high levels of accuracy, the rules can be modified or eliminated by the calibration module 210. Likewise, if certain rules require consideration of certain attributes that do result in identification of household membership with high levels of accuracy, the rules can be adjusted by the calibration module 210 to decrease or eliminate consideration of those attributes. Similarly, if certain rules employ minimum (or maximum) match values that do not result in identification of household membership with high levels of accuracy, the minimum match values can be adjusted by the calibration module 210 to improve accuracy. Many variations are possible.

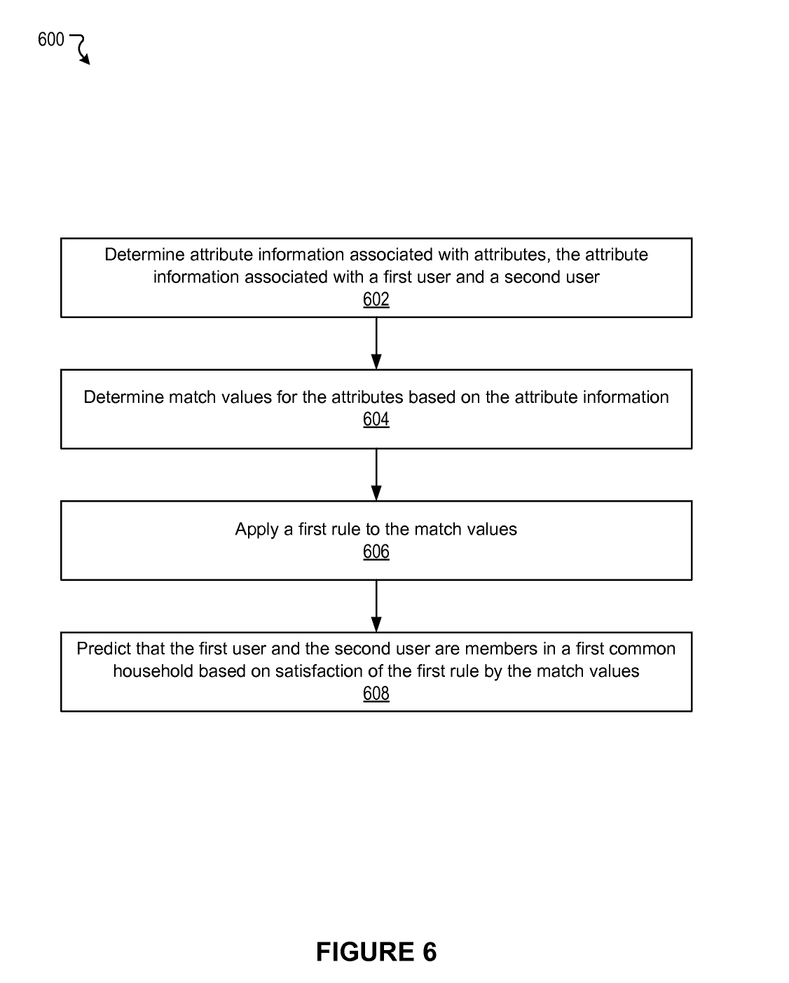

FIG. 6 illustrates an example method 600 associated with providing a determination of common household membership, according to an embodiment of the present disclosure. It should be appreciated that there can be additional, fewer, or alternative steps performed in similar or alternative orders, or in parallel, within the scope of the various embodiments unless otherwise stated.

At block 602, the example method 600 can determine attribute information associated with attributes, the attribute information associated with a first user and a second use. At block 604, the example method 600 can determine match values for the attributes based on the attribute information. At block 606, the example method 600 can apply a first rule to the match values. At block 608, the example method 600 can predict that the first user and the second user are members in a first common household based on satisfaction of the first rule by the match values. Many variations are possible.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include an household determination module 746. The household determination module 746 can, for example, be implemented as the household determination module 102 of FIG. 1. As discussed previously, it should be appreciated that there can be many variations or other possibilities. For example, in some instances, the household determination module 746 (or at least a portion thereof) can be included in the user device 710. Other features of the household determination module 746 are discussed herein in connection with the household determination module 102.

### Hardware Implementation

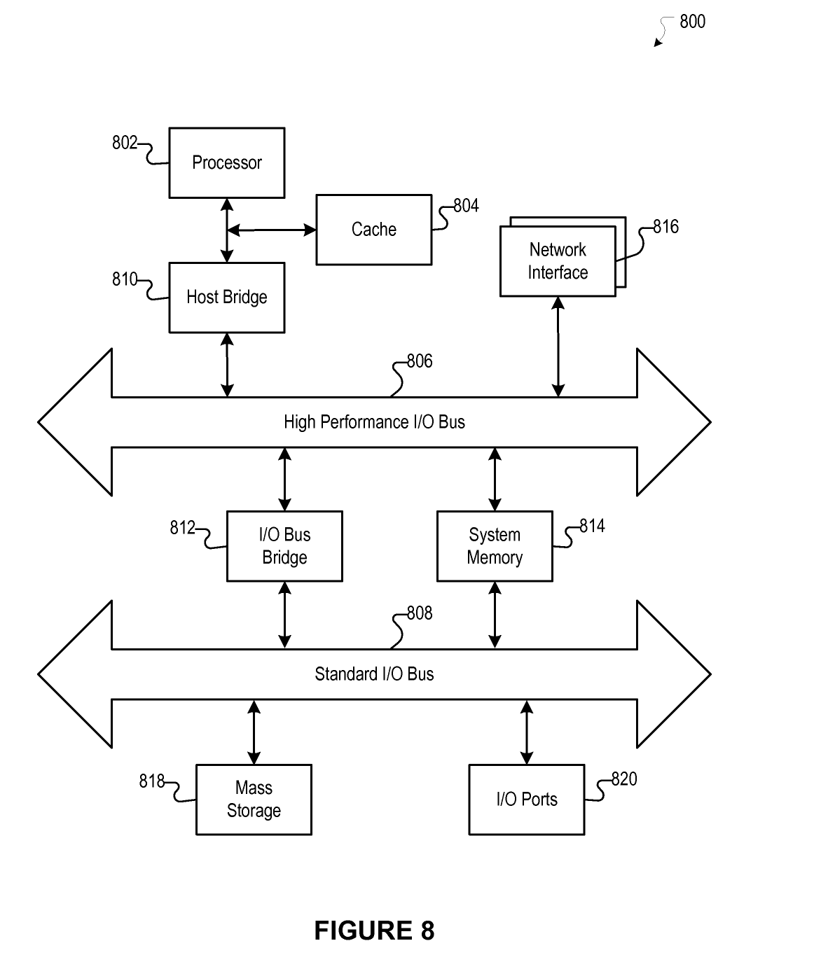

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, attribute information associated with attributes, the attribute information associated with a first user and a second user;
determining, by the computing system, match values for the attributes based on the attribute information;
applying, by the computing system, a first rule to the match values; and
predicting, by the computing system, that the first user and the second user are members in a first common household based on satisfaction of the first rule by the match values.

2. The computer-implemented method of claim 1, wherein the determining match values comprises:
determining an extent to which a condition associated with an attribute is satisfied; and
assigning a match value based on the extent to which the condition associated with the attribute is satisfied.

3. The computer-implemented method of claim 1, wherein the attributes include at least one of a friend attribute, a tie-strength attribute, a spouse attribute, a parent attribute, a shared device attribute, a zip code attribute, a city attribute, an IP address attribute, a last name attribute, and an age attribute.

4. The computer-implemented method of claim 1, wherein the first user is a member of a social networking system and the attribute information associated with the first user is known by the social networking system.

5. The computer-implemented method of claim 1, wherein the at least one rule includes a set of requirements associated with at least a subset of the attributes.

6. The computer-implemented method of claim 5, wherein the set of requirements includes at least one of a minimum match value, a maximum match value, and an identical match value associated with an attribute.

7. The computer-implemented method of claim 1, further comprising:
applying a second rule to the match values when the first rule is not satisfied, the second rule including a set of requirements different from a set of requirements included in the first rule.

8. The computer-implemented method of claim 1, further comprising:
predicting that the second user and a third user are in a second common household based on satisfaction of a second rule;
determining that the first user, the second user, and the third user are in a common household without application of the first rule and the second rule.

9. The computer-implemented method of claim 1, further comprising:
identifying the first user and the second user as a pair for determination of possible common household membership based on at least one match associated with a threshold number of attributes.

10. The computer-implemented method of claim 1, further comprising:
applying a machine learning technique to update a set of requirements associated with the first rule based on accurate household membership information.

11. A system comprising:
at least one processor; and
a memory storing instructions that, when executed by the at least one processor, cause the system to perform:
determining attribute information associated with attributes, the attribute information associated with a first user and a second user;
determining match values for the attributes based on the attribute information;
applying a first rule to the match values; and
predicting that the first user and the second user are members in a first common household based on satisfaction of the first rule by the match values.

12. The system of claim 11, wherein the determining match values comprises:
determining an extent to which a condition associated with an attribute is satisfied; and
assigning a match value based on the extent to which the condition associated with the attribute is satisfied.

13. The system of claim 11, wherein the attributes include at least one of a friend attribute, a tie-strength attribute, a spouse attribute, a parent attribute, a shared device attribute, a zip code attribute, a city attribute, an IP address attribute, a last name attribute, and an age attribute.

14. The system of claim 11, wherein the first user is a member of a social networking system and the attribute information associated with the first user is known by the social networking system.

15. The system of claim 11, wherein the at least one rule includes a set of requirements associated with at least a subset of the attributes.

16. A non-transitory computer-readable storage medium including instructions that, when executed by at least one processor of a computing system, cause the computing system to perform:
determining attribute information associated with attributes, the attribute information associated with a first user and a second user;
determining match values for the attributes based on the attribute information;
applying a first rule to the match values; and
predicting that the first user and the second user are members in a first common household based on satisfaction of the first rule by the match values.

17. The non-transitory computer-readable storage medium of claim 16, wherein the determining match values comprises:
determining an extent to which a condition associated with an attribute is satisfied; and
assigning a match value based on the extent to which the condition associated with the attribute is satisfied.

18. The non-transitory computer-readable storage medium of claim 16, wherein the attributes include at least one of a friend attribute, a tie-strength attribute, a spouse attribute, a parent attribute, a shared device attribute, a zip code attribute, a city attribute, an IP address attribute, a last name attribute, and an age attribute.

19. The non-transitory computer-readable storage medium of claim 16, wherein the first user is a member of a social networking system and the attribute information associated with the first user is known by the social networking system.

20. The non-transitory computer-readable storage medium of claim 16, wherein the at least one rule includes a set of requirements associated with at least a subset of the attributes.
